(19) United States
(12) Patent Application Publication
(10) Pub. No.: US 2024/0112176 A1
(43) Pub. Date: Apr. 4, 2024

(54) CRYPTO-BASED TRANSACTION FRAUD PROTECTION

(71) Applicant: NCR Corporation, Atlanta, GA (US)

(72) Inventor: Kamran Khashayar Fekri, Guelph (CA)

(21) Appl. No.: 17/957,258

(22) Filed: Sep. 30, 2022

(51) Int. Cl. G06Q 20/36; G06Q 20/38; G06Q 20/40

(52) U.S. Cl. CPC G06Q 20/3674; G06Q 20/3825; G06Q 20/3829; G06Q 20/4016

(57) ABSTRACT

A fiat currency transaction is assured with cryptocurrency collateral. The fiat transaction workflow is modified to perform an out-of-band workflow during which one of the parties to the fiat transaction provides a verifiable blockchain (BC) wallet-to-wallet transfer command to move cryptocurrency in a collateralized amount from a wallet of the party to a wallet associated with the other party. The command is not submitted to the BC and is held in abeyance by a cloud service until there is assurance of no fraud at which time the command is deleted. If fraud is reported, the command is sent to the BC for execution and the defrauded party receives the collateralized amount in a wallet associated with the defrauded party.

### BACKGROUND

Preventing fraud requires an enormous amount of resources and time, especially in digital environments during online transactions. Online fraud is often detected after the damage has been done to the parties involved at that point the assets associated with the fraud are often lost, untraceable, and irretrievable.

Ironically, cryptocurrency transactions are more secure than online fiat currency transactions. This is because strong cryptographic encryption is processed with cryptocurrency transactions which is difficult if not impossible to penetrate. Theft would require knowing an individual's wallet identifier as well as having the public and private cryptographic keys that is used by that individual for their wallet. The cryptographic keys are large character strings or phrases needed for the strong encryption used.

Conversely, fiat currency transactions are often based on weak encryption and the parties often use weak passwords or keys that can be discovered through free online password breaking algorithms by any would-be hacker. Furthermore, with fiat currency transactions the parties have no secure and easy way to verify the assets of the parties. Each party likely uses a different financial institution and there are few if any financial systems that permit communication other external financial systems for purposes of verifying of assets in an online transaction. Rather, financial institutions heavily restrict how and when external systems can access their internal systems and they require specific authorizations when access is granted. Obtaining proper authorizations for access can take days not seconds, which are likely needed for any in progress online transaction.

As a result, financial systems rely on technology that attempts to identify fraud before the online transaction is initiated for processing, such that the transaction is prevented from processing if fraud is suspected. The technology often scores factors associated with the parties, the financial institutions involved, and the details of the transaction to thwart fraud and compares the score against a threshold score to decide whether to permit or deny a given online transaction. But thieves discover how the scoring is done and manipulate the factors and/or the thieves know that authorizations can take days not seconds; they use this information to their advantage to circumvent the fiat currency fraud technology and commit fraud. Thus, online fiat currency fraud is still a substantial problem in the industry.

### SUMMARY

In various embodiments, methods and a system for crypto-based transaction fraud protection are presented. A fiat currency transaction between two parties is collateralized with an out-of-band workflow to the transaction workflow during which one party submits and provides a verifiable blockchain wallet-to-wallet cryptocurrency transfer command, which is fully executable on the blockchain, for the agreed to collateralized amount of the fiat currency transaction. The blockchain wallet-to-wallet cryptocurrency transfer command is held in abeyance by an independent cloud service for the parties and is not submitted for execution to the blockchain. If no fraud is reported, the command is deleted and is never submitted to the blockchain to perform the transfer. If fraud is detected, the command is submitted to the blockchain, and a wallet associated with the party that was defrauded is reimbursed their loss by the collateralized amount in cryptocurrency being transferred to a wallet associated with the defrauded party.

### BRIEF DESCRIPTION OF THE DRAWINGS

FIG. 1 is a diagram of a system for crypto-based transaction fraud protection, according to an example embodiment.

FIG. 2 is a diagram of a method for crypto-based transaction fraud protection, according to an example embodiment.

FIG. 3 is a diagram of another method SSI verifiable credentials for consumer consent processing, according to an example embodiment.

### DETAILED DESCRIPTION

As stated above, fiat-currency online transactions are subject to unreasonable amounts of fraud. Every time a new technology is provided to stop a fraud technique, a new evasive technique is developed by hackers to render that new technology out of date. This is an ongoing cycle that appears to be never ending.

One type of fraud is associated with a transaction that involves taking a loan in exchange for proof of collateral by the debit to the lender. The debtor may be trying to commit the fraud when after showing the proper collateral to the lender and receiving the loan, the debtor moves or spends the collateral. Conversely, a true debtor may not actually be the debtor involved in the transaction such as when the true debtor's identity and/or details on the true debtor's collateral were stolen by the debtor involved in the transaction. A transaction associated with a secure loan is often referred to as a collateralized loan or transaction. Fraud associated with collateralized loans can involve large sums of currency. Yet, these types of transactions are frequent between large institutions and banks on a daily basis. As a result, collateralized loan transaction fraud can have enormous impacts on the parties should a hacker pose as a large institution or a bank to receive the loan payout from another large institution or bank.

The above-referenced problem with online transaction fraud and with collateralized loan transactions are remedied with the teachings presented herein and below. An online fiat currency transaction is collateralized by a first party to the transaction who is to receive a payment of fiat currency or is to receive a transfer of an asset in the transaction using cryptocurrency assets held in a cryptographic wallet by that party. The first party generates a blockchain transfer request, which is digitally signed with a public key associated with the payer's wallet and a private key of the first party's wallet and the signed blockchain transfer request is send to a cloud-based service. The blockchain transfer request can be executed if submitted to the blockchain by the cloud-based service but the cloud-based service holds onto the transfer request until confirmation is received from the payer that the transaction completed and was non fraudulent.

When the transaction was non-fraudulent, the cloud-based service deletes the transfer request. Conversely, if the transaction was determined to be fraudulent by the payer, the cloud-based service submits the blockchain transfer request to the blockchain causing the cryptocurrency assets to transfer from the wallet of the first party to a wallet associated with or held in custody for the payer. Because the cloud-based service has the public key of the payer and the wallet identifier of the payer with the held block transfer request, the cloud-based service can verify over the blockchain that the first party has sufficient cryptocurrency assets for the collateral associated with the fiat currency transaction and can monitor the payor's wallet for pending transactions against the payor's wallet. Should a pending transaction against the payor's wallet reduce a balance of the wallet to below what is needed for the collateral, the cloud-based service can notify the payer to deny approval of the transaction. This provides fraud protection to the payor of the online fiat currency transaction, such that when fraud is detected the payor does not suffer a loss or the loss is substantially lessened.

There is no need for any verification of assets for the collateral with a bank of the first party since cryptocurrency assets are used as the collateral and wallets are viewable from or transparent on the blockchain. There is also no way for the first party to revoke the blockchain transfer request once it is signed with the private key by the first party and provided to the cloud-based service.

Moreover, any party to a transaction that is a bank can have a custodial wallet managed by the cloud-based service, such that the bank is not handling or dealing with cryptocurrencies. The cloud-based service can redeem the cryptocurrency retained as collateral during a fraudulent online transaction on the blockchain for fiat currency and transfer the fiat currency directly to a financial account associated with the bank.

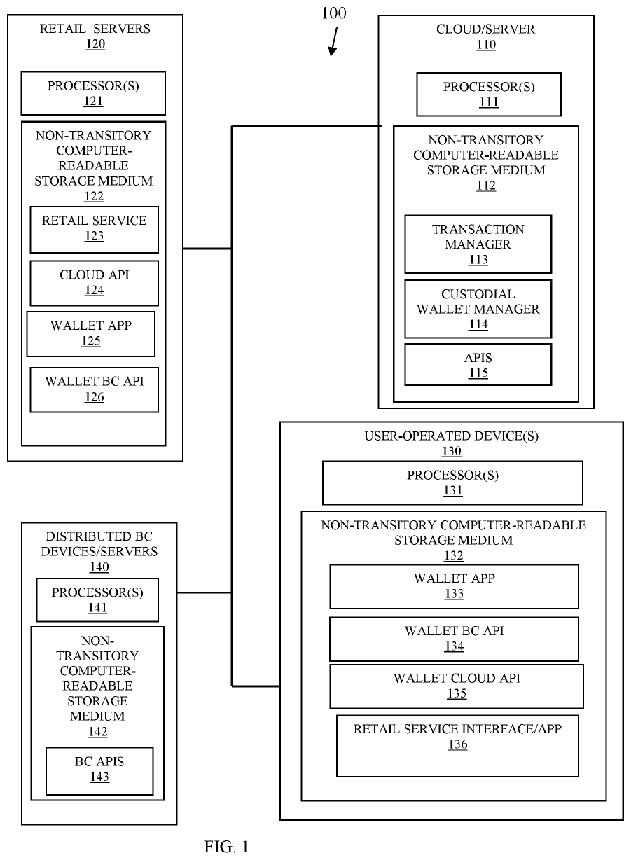

FIG. 1 is a diagram of a system 100 for crypto-based transaction fraud protection, according to an example embodiment. The system 100 is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from the crypto-based transaction fraud protection presented herein and below.

Moreover, various components are implemented as one or more software modules, which reside in non-transitory storage and/or hardware memory as executable instructions that when executed by one or more hardware processors perform the processing discussed herein and below.

As used herein the phrase “blockchain (BC) transfer request” is intended to mean an executable BC command that when submitted to the BC moves cryptocurrency from one cryptocurrency wallet to another cryptocurrency wallet. A non-submitted BC transfer request is one that is fully executable on the BC but has not yet been submitted to the BC such that is does not show as a pending transaction on the wallets and is unknown to the BC until it is submitted. A BC transfer request is signed with a private key of the wallet/user from which the funds are being transferred out of and is verifiable based with a public key of the wallet, such that a non-submitted BC transfer can be cryptographically verified without submitting it to the BC for execution. The phrases “BC transfer” and BC transaction” may be used interchangeable and synonymously herein and below. This refers to an executable wallet-to-wallet transfer command by the BC that transfers cryptocurrency from one wallet to another wallet.

System 100 includes a cloud 110 or a server 110 (hereinafter referred to as “cloud 110”), retail servers 120, user-operated devices 130, and distributed blockchain (BC) 140. Cloud 110 includes at least one processor 111 and a non-transitory computer-readable storage medium (hereinafter “medium”) 112, which includes executable instructions for a transaction manager 113, custodial wallet manager 114, and Application Programming Interfaces (APIs) 115. The instructions when provided to processor 111 cause processor 111 to perform operations discussed herein and below for 113-115.

Each retail server 120 includes at least one processor 121 and medium 122, which includes executable instructions for a retail service 123, cloud API 124, a wallet application (app) 125, and wallet BC API 126. The instructions when provided to processor 121 cause processor 121 to perform operations discussed herein and below for 123-126.

Each user-operated device 130 comprises one or more processors 131 and medium 132, which includes executable instructions for a wallet app 133, wallet BC API 134, wallet cloud API 135, and a retail service interface/app 136. When the executable instructions are provided to processor 131, this causes processor 131 to perform operations discussed herein and below 133-136.

Distributed BC devices/servers comprises processors 141 and a non-transitory computer readable storage medium 142 for each BC device/server 140. Medium 140 comprises executable instructions for BC APIs 143. When the executable instructions are provided to corresponding processor 141, this causes processor 141 to perform operations discussed herein and below for BC APIs 143.

Initially, a user or a first party to a fiat currency online transaction operates a user interface of retail service app 136 to engage in a transaction with a retailer that provides retail service 123 via retail server 120. The workflow associated with the transaction provides a user interface option to provide collateral for the transaction by the user via a cloud service associated with transaction manager 113 of cloud 110. When the user selects the option, the user is asked to provide the collateralized amount in cryptocurrency from a user's cryptocurrency wallet app 133 to a wallet identifier associated with a custodial wallet managed by custodial wallet manager 114 on behalf of the retailer. The user interface of retail app 136 requests that the user open wallet app 133 and scan an identifier from the interface screen for the custodial wallet identifier of the custodial wallet associated with the retailer. After scanning the custodial wallet identifier, the user interface of wallet app 133 requests the user enter the collateralized amount of cryptocurrency being transferred from the user's wallet to the custodial wallet.

Once the custodial wallet identifier and the collateralized amount is entered, wallet app 133 digitally signs with a private key of the user and a public key of the custodial wallet the user's wallet identifier, the custodial wallet identifier, and the amount to transfer as a BC wallet-to-wallet cryptocurrency transfer request. However, rather than wallet app 133 submitting the transfer to distributed BC devices/servers 140 for execution on the BC, wallet app 133 uses wallet cloud API 135 to send the signed BC and non-submitted transfer request to transaction manager 113. While the user is operating the user interface of wallet app 133, the original workflow for the user interface of retail service app sends a notification to transaction manager 113 that includes a retailer identifier for the retailer, a transaction identifier for the transaction, the collateralized amount requested for the transaction, and a device identifier for the device 130 of the user. Thus, when wallet cloud API 135 sends the non-submitted BC transfer request to transaction manager 113, transaction manager 113 associates the transfer request with the retailer, the collateralized amount, and the user.

Transaction manager uses the wallet identifier for the wallet of the user and a public key associated with the user's wallet to verify that the collateralized amount is available in the user's wallet on the BC and that no pending transactions against the user's wallet would reduce a balance of the wallet below the collateralized amount by using a BC API 115 and interacting with BC APIs 143. This is cryptographically verifiable on the BC with the public key of the user's wallet to verify the digital signature of the user and with the user's wallet identifier to identify the wallet and its balance or pending transaction on the BC. The signature on the BC transfer request, the public key, and the user's wallet identifier are all included in the BC transfer request. Assuming the transaction is verified by the signature and the wallet exists on the BC with at least the collateralized amount needed, transaction manager 113 sends a notice to cloud API 124 that indicates the transaction identifier, the collateralized amount, and a confirmation flag indicating that transaction manager 113 is in possession of the signed BC transfer request. Retail service 123 then performs initial fraud checks on the transaction and authorizes the transaction with the user through retail service app 136 or denies the transaction for detected fraud. Retail service 123 uses cloud API 124 to indicate whether the transaction was good and not fraud or was not good and was fraud. Transaction manager 113 deletes the non-submitted BC transfer request when the transaction was good, the BC transfer in the collateralized amount is never recorded on the BC against the user's wallet.

In an embodiment, transaction manager 113 continuously monitors the user's wallet on the BC for pending transactions while the transaction is being processed and has not been identified as approved or cleared by the retailer. At any point in time before being cleared by the retailer that the transaction manager 113 identifies a pending BC transfer request or pending BC transaction, transaction manager 113 notifies the retailer through Cloud API 124 so that the retailer can cancel the transaction pending between the retailer and the user.

However, when the cloud API 124 reports fraud, custodial wallet manager 114 submits the BC transfer request to the BC using a BC API 115 and interacting with BC APIs of distributed BC devices/servers 140. This causes the cryptocurrency collateralized amount to transfer from the user's wallet to a custodial wallet associated with the retailer. Any value provided to the user for the transaction is reimbursed back to the retailer when fraud was detected.

In an embodiment, custodial wallet manager 114 redeems the cryptocurrency from the custodial wallet of the retailer into a stable cryptocurrency such as U.S. dollar coin (USDC) and uses a custodial financial account held by cloud 110 to transfer fiat currency funds associated with the collateralized amount to a financial account of the retailer. The collateralized amount in the USDC can be sold at any time by a provider associated with cloud 110 such that the provider does not maintain any risks associated with holding cryptocurrency assets. In this way, the retailer does not hold nor deal in cryptocurrency, which is significant if the retailer is a financial institution since there are regulations that prohibit this assumption of risk by financial institutions. Moreover, the risk to cloud 110 is minimal when the cryptocurrency is converted into the stable cryptocurrency and/or sold/redeemed via a cryptocurrency exchange for fiat currency.

In an embodiment, the retailer maintains their own wallet via wallet APP 125 using wallet BC API 126. In this embodiment, the wallet identifier presented for scanning by the user within the user interface of retail service app 136 is the wallet identifier for the retailer's wallet. However, wallet cloud API 135 still sends the non-submitted BC transfer to transaction manager 113 and transaction manager 113 only submits the BC transfer request over the BC when the retailer through cloud API 124 indicates that the transaction was fraudulent, and the retailer has already provided something of value to the user for the transaction.

It is noted that there are a variety of manners by which transaction manager 113 can link a given transaction for a given retailer and a given user to a non-submitted BC transfer request for using the user's cryptocurrency as collateral for the transaction between the user and the retailer. For example, cloud API 124 can be integrated within a workflow associated with retail service and provide the transaction identifier and the user device identifier along with the collateralized amount when the user selects the option from user interface of retail service app 136 to uses cryptocurrency. Wallet APP 133 may identify through the wallet identifier scanned for the custodial/retail wallet and uses an additional API to interact with app 133 to obtain the transaction identifier and the collateralized amount. App 133 may use an AIP to notify wallet app 133 and/or wallet cloud API of the transaction identifier and collateralized amount as soon as the user selects the collateralized option from the user interface screen of app 133 during the workflow for the transaction. In fact, a variety of workflows can be used for the transaction manager 113 to link a non-submitted BC transfer request to the user, the collateralized amount, the transaction, and the retailer.

The non-submitted BC transfer request is in fact a BC wallet-to-wallet transaction. It includes all that is needed to move securely the defined collateralized amount from the user's wallet on the BC to the retailer/custodial wallet on the BC. It is signed with the private key of the user and is a valid transaction all that remains is for the transfer request to actually be submitted to the BC, which does not occur unless the retailer through cloud API 124 notifies transaction manager 113. Again, when there is no fraud there is no BC transfer that happens on the BC and the transfer request is deleted by transaction manager 113. Therefore, there is no BC transaction fee associated with processing the BC transfer.

In an embodiment, the user is another retailer. That is the two parties to a fiat currency transaction can both be retailers, such as two banks, two retailers associated with a same type of business, or two retailers associated with different types of business.

System 100 prevents a fraudster from even attempting the fraud in the first instance because the fraudster would have to have sufficient cryptocurrency and produce a verifiable BC transfer before the transaction is processed. If fraud is detected the other party receives their lost assets. System 100 uses cryptocurrency assets as collateral for fiat currency transactions providing fraud protection for the parties involved in the fiat currency transaction by ensuring one party is made whole if fraud occurs with the collateralized cryptocurrency.

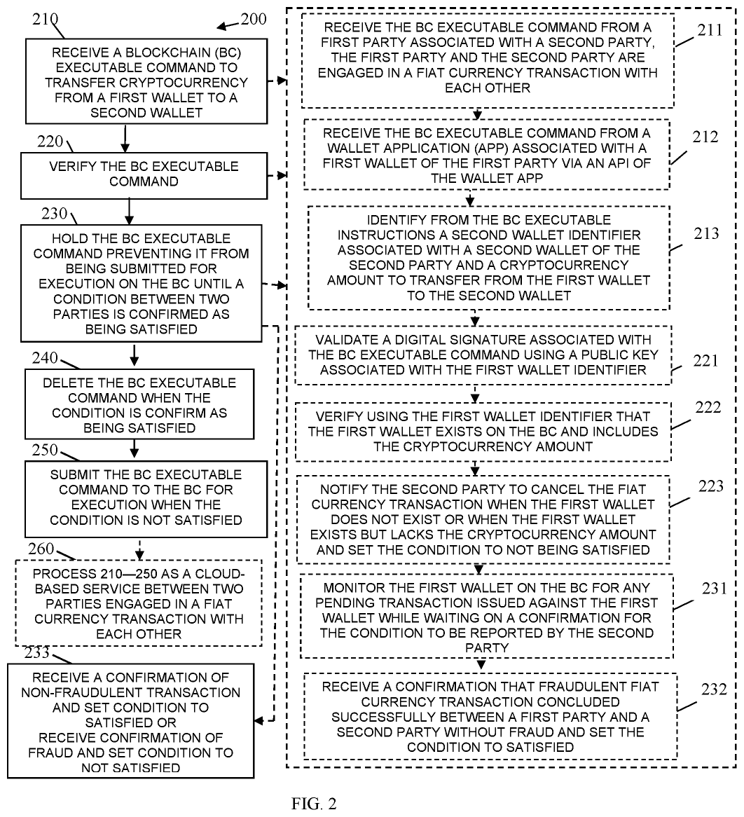

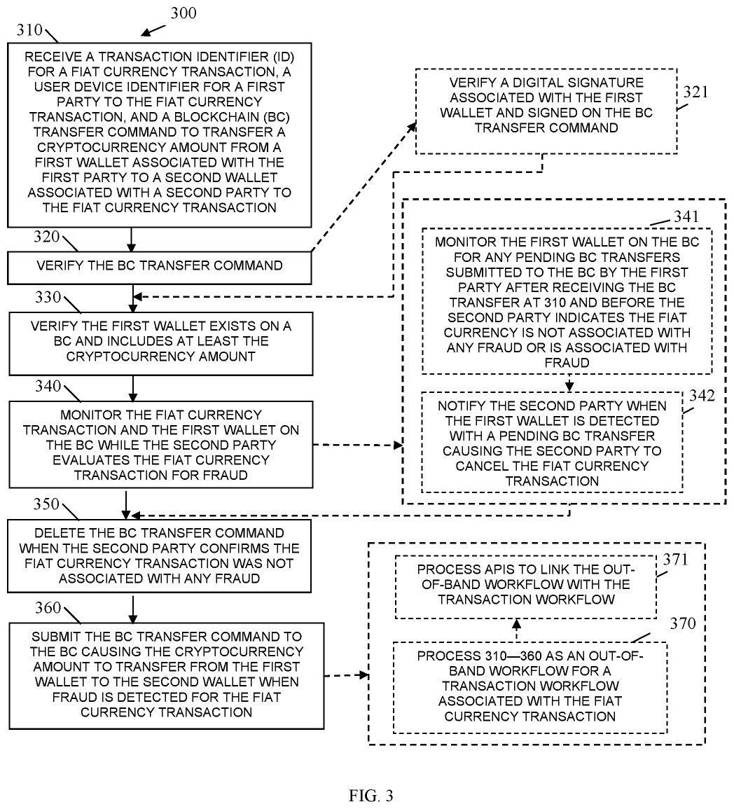

The embodiments of FIG. 1 and other embodiments are now discussed with reference to the FIGS. 2-3. FIG. 2 is a diagram of a method 200 for crypto-based transaction fraud protection, according to an example embodiment. The software module(s) that implements the method 200 is referred to as a “fraud protection manager.” The fraud protection manager is implemented as executable instructions programmed and residing within memory and/or a non-transitory computer-readable (processor-readable) storage medium and executed by a plurality of hardware processors of a plurality of hardware computing devices. The processors of the devices that execute the fraud protection manager are specifically configured and programmed to process the fraud protection manager. The fraud protection manager has access to one or more networks during its processing. The networks can be wired, wireless, or a combination of wired and wireless.

In an embodiment, the devices that execute the fraud protection manager is cloud 110 or server 110. In an embodiment, the fraud protection manager is transaction manager 113, custodial wallet manager 114, and APIs 115.

At 210, the fraud protection manager receive a BC executable command to transfer cryptocurrency from a first wallet to a second wallet. In an embodiment, at 211, the fraud protection manager receives the BC executable command from a first party and associated with a second party. The first party and the second party are engaged in a pending fiat currency transaction with one another.

In an embodiment, at 212, the fraud protection manager receives the BC executable command from a wallet app 133 associated with a first wallet of the first party via an API 135 of the wallet app 133. In an embodiment, at 213, the fraud protection manager identifies from the BC executable command a second wallet identifier associated with a second wallet of the second party to transfer from the first wallet to the second wallet.

At 220, the fraud protection manager verifies or validates the BC executable command. In an embodiment of 213 and 220, at 221, the fraud protection manager validates a digital signature associated with the BC executable command using a public key associated with the first wallet identifier for the first wallet.

In an embodiment of 221 and at 222, the fraud protection manager verifies, using the first wallet identifier, that the first wallet exists on a BC and that the first wallet identifier includes at least the cryptocurrency amount. In an embodiment of 222, and at 223, the fraud protection manager notifies the second party to cancel the fiat currency transaction when the first wallet does not exist or when the first wallet exists but lacks the cryptocurrency amount and when this occurs set a condition to not being satisfied.

At 230, the fraud protection manager holds the BC executable command prevent the BC executable command from being submitted for execution on the BC until a condition between two parties is confirmed as being satisfied. In an embodiment of 223 and 230, at 231, the fraud protection manager monitors the first wallet on the BC for any pending BC transfers issued against the first wallet while waiting on a confirmation for the condition to be reported by the second party. In an embodiment of 231 and at 232, the fraud protection manager receives a confirmation that the fiat currency transaction concludes successfully between the first party and the second party without any detected fraud; the fraud protection manager sets the condition to satisfied.

In an embodiment of 230, at 233, the fraud protection manager receives a confirmation of a non-fraudulent transaction. In response, the fraud protection manager sets the condition to satisfied or, at 233, the fraud protection manager receives a confirmation of fraud and sets the condition to not satisfied.

At 240, the fraud protection manager detected the BC executable command when the condition is confirmed as being satisfied. In an embodiment, the condition can be any agreed to contractual provision between two or more parties such that it can be more than just a fiat currency transaction.

At 250, the fraud protection manager submits the BC executable command to the BC for execution when the condition is not satisfied. As a result, a wallet-to-wallet cryptocurrency transfer between parties is performed on behalf of one party to protect that party from fraud associated with the condition.

In an embodiment, at 260, the fraud protection manager (210-250) processes and is provided as a cloud-based service between two parties engaged in a fiat currency transaction with each other. The fraud protection manager provides fraud protection for at least one of the parties engaged in the fiat currency transaction.

FIG. 3 is a diagram of another method 300 for crypto-based transaction fraud protection, according to an example embodiment. The software module(s) that implements the method 300 is referred to as a “transaction manager.” The transaction manager is implemented as executable instructions programmed and residing within memory and/or a non-transitory computer-readable (processor-readable) storage medium and executed by one or more hardware processors of one or more hardware devices. The processors of the devices that execute the transaction manager are specifically configured and programmed to process the transaction manager. The transaction manager has access to one or more networks during its processing. The networks can be wired, wireless, or a combination of wired and wireless.

The transaction manager presents another and, in some ways, enhanced processing perspective of that which was described above with system 100 and method 200. In an embodiment, the device that executes the transaction manager is cloud 110 or server 110. In an embodiment, the transaction manager is all or some combination of transaction manager 113, custodial manager 114, APIs 115, and/or method 200 of FIG. 2.

At 310, the transaction manager receives a transaction identifier for a fiat currency transaction, a user device identifier for a first party to the fiat currency transaction, and a BC transfer command. The BC transfer command to transfer a cryptocurrency amount from a first wallet associated with the first party to a second wallet associated with a second party to the fiat currency transaction.

At 320, the transaction manager verifies or validates the BC transfer command. In an embodiment, at 321, the transaction manager verifies a digital signature associated with the first wallet and signed on the BC transfer command.

At 330, the transaction manager verifies the first wallet exists on a BC. The transaction manager also verifies or validates that the first wallet includes at least the cryptocurrency amount.

At 340, the transaction manager monitors the fiat currency transaction and the first wallet on the BC while the second party evaluates the fiat currency transaction for fraud. In an embodiment, at 341, the transaction manager monitors the first wallet on the BC for any pending BC transfers submitted to the BC by the first party after 310 and before the second party indicates that the fiat currency transaction is or is not associated with any fraud. In an embodiment of 341 and at 342, the transaction manager notifies the second party when the first wallet is detected with a pending BC transfer this notification causes the second party to cancel the fiat currency transaction.

At 350, the transaction manager deletes the BC transfer command when the second party confirms the fiat currency transaction was not associated with any fraud. The transfer of the cryptocurrency amount from the first wallet of the first party is not transferred to the second wallet of the second party.

At 360, the transaction manager submits the BC transfer command to the BC causing the cryptocurrency amount to transfer from the first wallet of the first party to the second wallet associated with the second party when fraud is detected for the fiat currency transaction. In an embodiment, at 370, the transaction manager processes as an out-of-band workflow for a transaction workflow associated with the fiat currency transaction. That is, the fiat currency transaction processes within a transaction workflow and an out-of-band workflow is processed as the transaction manager. In an embodiment of 370 and at 371, the transaction manager processes APIs 115, 124, and 135 to link the out-of-band workflow with the transaction workflow.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving a blockchain (BC) executable command to transfer cryptocurrency from a first wallet to a second wallet;
verifying the BC executable command;
holding the BC executable command preventing it from being submitted for execution on a BC until a condition between two parties is confirmed as being satisfied;
deleting the BC executable command when the condition is confirmed as satisfied; and
submitting the BC executable command to the BC for execution when the condition is not satisfied.

2. The method of claim 1, wherein receiving further includes receiving the BC executable command from a first party associated with a second party, wherein the first party and the second party are engaged in a fiat currency transaction with each other.

3. The method of claim 2, wherein receiving further includes receiving the BC executable command from a wallet application associated with a first wallet of the first party via an Application Programming Interface (API) of the wallet application.

4. The method of claim 3, wherein receiving further includes identifying from the BC executable command a second wallet identifier associated with a second wallet of the second party and a cryptocurrency amount to transfer from the first wallet to the second wallet.

5. The method of claim 4, wherein verifying further includes validating a digital signature associated with the BC executable command using a public key associated with the first wallet identifier.

6. The method of claim 5, wherein verifying further includes verifying, using the first wallet identifier, that the first wallet exists on the BC and includes the cryptocurrency amount.

7. The method of claim 6, wherein verifying further includes notifying the second party to cancel the fiat cryptocurrency transaction when the first wallet does not exist or when the first wallet exists but lacks the cryptocurrency amount and setting the condition to not being satisfied.

8. The method of claim 7, wherein holding further includes monitoring the first wallet on the BC for any pending transactions issued against the first wallet while waiting on a confirmation for the condition to be reported by the second party.

9. The method of claim 8, wherein monitoring further includes notifying the second party when a pending transaction is issued against the first wallet and setting the condition to not being satisfied.

10. The method of claim 1, wherein holding further includes receiving a confirmation that the fiat currency transaction concluded successfully between a first party and a second party without any detected fraud and setting the condition to satisfied.

11. The method of claim 1, wherein holding further includes receiving a confirmation that a fraudulent fiat currency transaction was detected between a first party and a second party and setting the condition to not being satisfied.

12. The method of claim 1 further comprising, processing the method as a cloud-based service between two parties engaged in a fiat currency transaction with each other.

13. A method, comprising:
receiving a transaction identifier for a fiat currency transaction, a user device identifier for a first party to the fiat currency transaction, and a blockchain (BC) transfer command to transfer a cryptocurrency amount from a first wallet associated with the first party to a second wallet associated with a party of the fiat currency transaction;
verifying the BC transfer command;
verifying the first wallet exists on a BC and includes at least the cryptocurrency amount;
monitoring the fiat currency transaction and the first wallet on the BC while the second party evaluates the fiat currency transaction for fraud; and
deleting the BC transfer command when the second party confirms the fiat currency transaction was not associated with any fraud;
submitting the BC transfer command to the BC to cause the cryptocurrency amount to transfer from the first wallet to the second wallet when fraud is detected for the fiat currency transaction.

14. The method of claim 13 further comprising, processing the method as an out-of-band workflow for a transaction workflow associated with the fiat currency transaction.

15. The method of claim 14, wherein processing further includes processing Application Programming Interfaces (APIs) to link the out-of-band workflow with the transaction workflow.

16. The method of claim 13, wherein verifying the BC transfer command further includes verifying a digital signature associated with the first wallet.

17. The method of claim 13, wherein monitoring further includes monitoring the first wallet on the BC for any pending BC transfers submitted to the BC by the first party after receiving the BC transfer command at 310 and before the second party indicates the fiat currency transaction is not associated with any fraud or is associated with fraud.

18. The method of claim 17, wherein monitoring further includes notifying the second party when the first wallet is detected with a pending BC transfer causing the second party to cancel the fiat currency transaction.

19. A system comprising:
a plurality of servers comprising a plurality of processors, each server comprises a non-transitory computer-readable storage media;
each non-transitory computer-readable storage medium comprising executable instructions for Application Programming Interfaces (APIs);
the APIs when executed by their corresponding processors performing operations comprising:
initiating an out-of-band workflow for a current fiat currency transaction between a first party and a second party;
obtaining a blockchain (BC) transfer command associated with the first party that when submitted to a BC causes a cryptocurrency amount in a first wallet of the first party to transfer to a second wallet associated with the second party;
preventing the BC transfer command from being submitted to the BC while the second party investigates the current fiat currency transaction for fraud;
monitoring the first wallet on the BC during the preventing for any pending BC transfers issued to the first wallet and notifying the second party when a pending BC transfer is detected on the first wallet;
deleting the BC transfer command when the second party indicates no fraud was associated with the current fiat currency transaction; and
submitting the BC transfer command to the BC to transfer the cryptocurrency amount from the first wallet of the first party to the second wallet associated with the second party when the second party indicates the current fiat currency transaction is associated with fraud.

20. The system of claim 19, wherein the first APIs are associated with a first DID identifier for a first digital wallet of the retailer, wherein the second APIs are associated with a second DID identifier for a second digital wallet of the consumer, and wherein the DID-based connection is processed as a blockchain to allow a wallet-to-wallet connection between the consumer-operated device and the retailer-operated device.
